(19) United States
(12) Patent Application Publication
(10) Pub. No.: US 2009/0271852 A1
(43) Pub. Date: Oct. 29, 2009

(54) System and Method for Distributing Enduring Credentials in an Untrusted Network Environment

(76) Inventors: Matt Torres, Corvallis, OR (US); Sally Blue Hoppe, Corvallis, OR (US); Jim Harritt, Albany, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/236,186

(22) Filed: Sep. 23, 2008

Related U.S. Application Data
(60) Provisional application No. 61/047,975, filed on Apr. 25, 2008.

(51) Int. Cl. H04L 9/32; G06F 21/00

(52) U.S. Cl. 726/6

(57) ABSTRACT

A system and method for distributing enduring credentials for a secure network in an untrusted network environment is disclosed. The method includes providing temporary credentials to an untrusted user. The temporary credentials can be communicated to a computing device connected to a network switch. The network switch can relay the temporary credentials to an authentication server within the secure network. The computing device can be authenticated to verify it is authorized to be connected to the secure network. Enduring credentials can be transmitted from the secure network to the computing device in an encrypted format to enable the computing device to communicate within the secure network through the network switch without providing access to the enduring credentials to the untrusted user.

### CROSS-REFERENCE TO RELATED APPLICATIONS

This Application claims the benefit of U.S. Provisional patent application Ser. No. 61/047,975, filed Apr. 25, 2008, which is hereby incorporated by reference in it's entirety.

### BACKGROUND

Routine actions are becoming automated through the use of computers and computer networks. Many actions that were once done between people can now be accomplished over the internet. Banking, government, and business are now routinely conducted over the internet and between networks each day. As more people conduct important business using computer networks, the need for network security has greatly increased. The ability to breach secure networks has gone from the exclusive capability of a few shadowy specialists to a profitable venture for organized crime, foreign governments, and corporate espionage. However, most companies have limited resources to fend off the increasing barrage of attempts to breach secure networks. To avert these network attacks, security measures can be taken to limit the public's access to a secure network.

### BRIEF DESCRIPTION OF THE DRAWINGS

FIG. 1 is an illustration of a block diagram of a system for distributing enduring credentials for a secure network in an untrusted network environment in accordance with an embodiment; and

FIG. 2 illustrates a flow chart depicting a method for distributing enduring credentials for a secure network in an untrusted network environment in accordance with an embodiment.

### DETAILED DESCRIPTION OF EXAMPLE EMBODIMENTS

Reference will now be made to the exemplary embodiments illustrated, and specific language will be used herein to describe the same. It will nevertheless be understood that no limitation of the scope of the invention is thereby intended.

Limiting access to a secure network can substantially reduce the threat of a network breach by an unwanted user. In a secure network that is designed to be accessed only by internal authorized users, such as a company's local area network (LAN), security can often be relaxed. For example, when a new employee arrives at a company, an information technology specialist typically sets up a computer and enters network access credentials into the computer that allow the computer to communicate through a network switch with the LAN. Network access credentials typically include a username and a password.

The network access credentials can be entered by the employee into their computer. The computer can communicate the credentials to a network switch. Certain types of networks switches are configured to send the credentials to an authentication server. Upon verification of the credentials from the authentication server, the network switch is configured to allow communication through the switch between the computer and other servers/computers within the LAN. In this scenario, the employee typically knows the network access credentials. The employee can often use these credentials to access the LAN using other computers, such as a laptop brought from home or other computers within the business. This limited security is often acceptable within a business, where an employee's ability to work efficiently is typically valued higher than increased network security. If an employee violates company policy with respect to the computer network, appropriate action can be taken by the company against the employee and the network security can be maintained.

Some types of networks are designed to be accessed by unknown individuals or computing devices that exist outside a secure network environment. For example, internet cafés, public libraries, hotels, airports, and other types of businesses catering to the public often allow access to the internet.

Other specialized types of networks are setup to allow access by certain types of individuals or devices for a specific purpose. For example, a specialized network for video conferencing can be configured that allows users to transmit high quality video and audio between video conferencing locations. The network can be designed to provide the bandwidth and appropriate networking configuration to ensure that the digital information representing the video and audio is transmitted and received in a timely manner. For example, the video conferencing network may be configured to communicate via an asynchronous transfer mode (ATM) networking standard that can ensure data packets arrive in a specific order. This enables the digital information representing the video and audio to arrive in an order that allows the high quality video and audio to be reliably reproduced without service interruptions.

A secure video conferencing network designed to provide high end video conferencing capabilities may be used to conduct important business between companies. These companies want assurance that any communication of proprietary information over the secure network remains private. Additionally, the network provider wants assurance that the network is functioning properly and available when needed for video conferencing clients.

The video conferencing network may be offered for use by the general public. Each client desiring to use the network can be given network access credentials that allow them access to the secure network. An individual may use the network access credentials to gain unintended access to the secure network, thereby breaching the network.

In order to allow unknown/untrusted members of the public to have access to a secure network, while minimizing unintended access to the network, a system and method for distributing enduring credentials in an untrusted computer environment has been developed. Enduring credentials, as used in this application, are credentials that are valid for an extended period of time. Enduring credentials are valid for a period of time greater than temporary credentials. However, enduring credentials are time limited and therefore are not considered to be permanent credentials. Enduring credentials may enable a user to be connected to a secure network for a period of days, weeks, or years, depending upon the specific situation. This will be discussed more fully below.

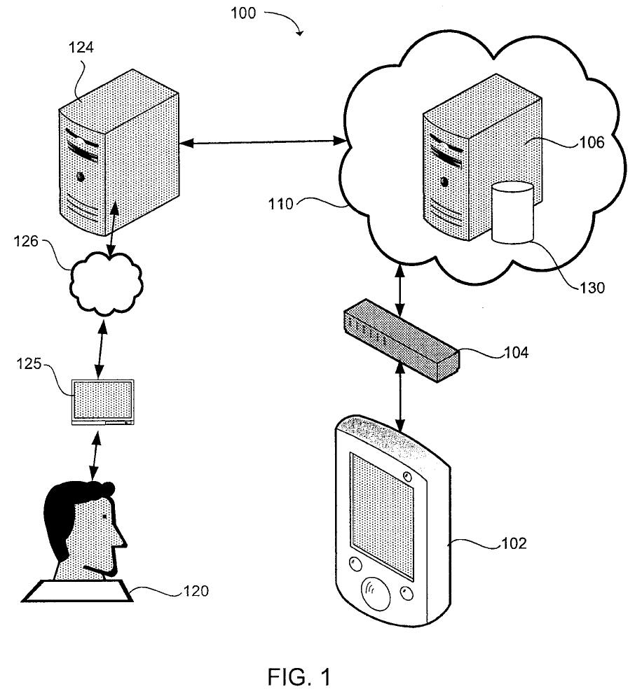

One embodiment of a system 100 for distributing enduring credentials in an untrusted computer environment is illustrated in FIG. 1. The system includes a computing device 102. The computing device can be configured to communicate through a network switch 104 to at least one server 106 within a secure network 110. The server may be a network access control server or some other type of computer configured to operate an authentication database. A separate credentials server 130 may also be used. Alternatively, the utility of the credentials server may be included in the network access control server.

In one embodiment, the computing device 102 can be a video endpoint in a video networking system. The video endpoint can be configured with a display, speakers, and a camera to allow video networking between two or more parties. The secure network can be configured to transmit digital data between the two or more parties. For example, digital audiovisual data may be relayed over the secure network between the video endpoint and another video endpoint.

In another embodiment, the computing device 102 can be a generic computing device configured to communicate with the secure network. For example, the computing device may be a laptop computer, a cell phone, a personal digital assistant, a gaming device, and the like.

The computing device 102 can be owned and/or operated by a user 120 that is unknown to the operator of the secure network 110. An unknown user is inherently an untrusted user since the network operator has no means of knowing or telling whether the unknown user has any nefarious intent with respect to the network. The untrusted user may also be an untrusted client that is an automated device configured to receive credentials and communicate them to the computing device.

If an untrusted user 120 is given permanent credentials to connect to the secure network 110, the untrusted user may use those credentials to connect unwanted devices to the network or to connect to locations within the network that are typically not allowed. The permanent credentials may allow the user to gain access to the network through repeated attempts. Thus, providing permanent credentials that are accessible to an unknown user to enable the user to gain access to a secure network can result in security violations within the secure network. The security violations may reduce the functionality of the secure network through unintended use. Security violations may also enable potential attacks to the network. Additionally, the security violations may allow untrusted users access to other clients' data, such as their proprietary information disclosed through video conferencing.

To reduce or eliminate potential security violations that may occur by providing permanent credentials to unknown users, one embodiment of the present invention provides temporary credentials to the unknown user. The temporary credentials may be sent to the unknown user using any standard procedure, such as by telephone, fax machine, or by computer. For example, FIG. 1 illustrates the unknown user 120 in communication with a server 124 through a computer 125 connected to the internet 126. The server may be a web server or some other type of demilitarized zone (DMZ) server that can be accessed by the public. The server 124 is located outside the secure network 110.

In one embodiment, the unknown user 120 can obtain temporary credentials by connecting with the server 124. The server may be accessible to the public via the internet 126 or another type of network. The server can include a software application that enables the user to obtain the temporary credentials that can be used to connect the computing device 102 with the secure network 110. The temporary credentials may be a password and username, or some other type of identifier, as previously discussed.

The temporary credentials can be valid for a set period. In one embodiment, the temporary credentials may provide access to the secure network 110 for a single instance. If the credentials are entered more than once, they will no longer be valid. However, human error or other technical difficulties that may occur when connecting the computing device 102 to the secure network 110 may require the credentials to be entered more than one time. If the single instance credentials were entered incorrectly and then became invalid, excessive time and effort may need to be spent with a customer support representative of the secure network. Therefore, the temporary credentials may be valid for a set period of time.

As an example of these operations, the computing device 102 can be a video endpoint used for video conferencing and the unknown/untrusted user 120 may be an information technology specialist working for a company that has purchased or leased the video endpoint and contracted with a provider of the secure network 110 to provide video conferencing capabilities between several branches of the business. The information technology specialist can connect the computing device to the network switch 104. The network switch can be connected to the secure network through a high bandwidth connection.

The unknown user 120 can obtain temporary credentials using a computer 125 connected to the server 124. For example, the server may be web server connected to the internet. The web server can be in communication with the secure network 110. The web server can be configured to communicate the temporary credentials to the unknown user through the computer 125 and replicate the credentials and send them to the network access control server 106 that is located within the secure network. The temporary credentials may be valid for 15 minutes, an hour, or longer. The unknown user can enter the temporary credentials into the computing device 102. The computing device can then communicate these temporary credentials to the network switch 104.

The network switch 104 can be configured to enable a connection between the secure network 110 and the computing device 102 only when the secure network has authorized the connection. However, in order to allow for authorization, the network switch is configured to allow certain types of data, such as credentials to be passed. The network switch can convey the temporary credentials from the computing device to the network access control server 106 located within the secure network.

The network access control server 106 can authenticate the temporary credentials communicated from the network switch and inform the switch 104 that the computing device is authorized to communicate with the secure network 110. The switch can then be set to an authorized state that enables communication between the computing device and the secure network. The computing device can then communicate with other devices within the secure network or devices connected to the secure network using conventional communications protocol such as file transfer protocol (FTP), hyper text transfer protocol (HTTP), and the like. The computing device can communicate on the secure network for the length of the time authorized to the temporary credentials.

At the end of the authorized length of time, the network access control server 106 will reset the switch 104 to an unauthorized state and the computing device 102 will no longer be allowed to communicate data on the secure network 110. In order to reauthorize communication between the computing device and the secure network, a new set of temporary credentials will have to be obtained from the web server 124 and authenticated as discussed above. However, this process would be unwieldy, requiring excessive work by the unknown client, causing frequent interruptions at the computing device 102, and taxing the network access control server 106.

Thus, while the use of temporary credentials can improve security by limiting the amount of time an unknown user 120 can access the secure network 106 through a connected computing device 102, the use of temporary credentials is limited from a business model perspective. A potential customer would likely not be willing to obtain and enter updated temporary credentials on a relatively frequent basis.

To overcome this problem, one embodiment of the present invention enables a system for distributing enduring credentials in an untrusted environment. As previously discussed, enduring credentials are valid for a period of time greater than temporary credentials. However, enduring credentials are time limited and therefore are not considered to be permanent credentials. Enduring credentials may enable a user to be connected to a secure network for a period of days, weeks, or years, depending upon the specific situation.

Nevertheless, it is still not desirable for the unknown/untrusted user 120 to have access to long term credentials, such as the enduring credentials. This may provide sufficient access to the network to enable an untrusted user to gain unwanted access. To surmount this obstacle, an authentication server such as the network access controller 106 located within the secure network 110 can be configured to provide enduring credentials to the computing device in an encrypted format.

In one embodiment, the enduring credentials can be provided by an authentication server such as the network access control server 106 within the secure network 110 after the computing device 102 has been connected to the secure network using the temporary credentials. The enduring credentials can be stored in a computer readable storage accessible by the authentication server. The computer readable storage can be magnetic storage, optical storage, solid state memory, and the like. Additionally, the authentication server or another computer within the secure network can be configured to authenticate the computing device to verify that an authorized computing device is being connected using the temporary credentials. Various details concerning the hardware, firmware, or software of the computing device can be communicated to the authentication server to enable the server to verify that the computing device 102 is authorized to be connected to the secure network. For example, a serial number of the computing device, the media access control (MAC) address of the computing device, the internet protocol (IP) address of the switch 104, the hardware configuration of the computing device, the type of software or firmware within the computing device, and so forth can be communicated from the computing device to the network access control server or another computer within the secure network to allow the computing device to be authenticated.

Once the computing device 102 has been authenticated, the network access control server 106 or another computer within the secure network 110 can configure the computing device to receive a set of enduring credentials. The enduring credentials can be passed from the secure network to the computing device in an encrypted format and stored within the computing device in the encrypted format.

The ability to communicate the enduring credentials directly from the secure network 110 to the computing device 102 in an encrypted format enables the computing device to be connected with the secure network for a substantial length of time without the need to provide open access to an unknown user 120. The enduring credentials can be encrypted and stored within the computing device in such a way that the unknown user is not able to gain access to the unencrypted enduring credentials.

The switch 104 can allow the computing device 102 to be connected to the secure network 110 for the length of time for which the enduring credentials have been authorized. The actual time can depend upon the system setup and various business considerations. In the video conferencing example that was previously discussed, a business may have a yearly or multi-year contract for access of the video endpoint to the secure network 110 to enable video conferencing to occur. The enduring credentials may be authorized for the length of the contract.

The network access controller 106 or another computer within the secure network 110 can be configured to monitor the connection between the computing device 102 and the secure network. If specific types of changes occur, the access gained using the encrypted enduring credentials can be terminated. For example, the network access controller can monitor the various details concerning the hardware, firmware, or software of the computing device and network switch 104 that were previously discussed. If some or all of these details change, the enduring credentials may be revoked.

In another example, a hotel guest may register his or her computer with a hotel. The hotel may then give the guest temporary credentials to connect with a wired or wireless secure network within the hotel. Upon verification that the computing device connected to the network was previously registered with the hotel, a network access control server within the hotel's network can be configured to communicate enduring credentials in an encrypted format. The enduring credentials may be authorized for the length of the guest's stay at the hotel. However, the guest will not have access to the actual credentials. Once the temporary credentials have expired or deleted from the guest's computer, only the encrypted enduring credentials stored on the guest's computing device can be used by the guest to gain access to the network. Any changes in the computing device may result in a termination of the credentials.

In one embodiment, the present system 100 can use a standard such as the Institute of Electrical and Electronics Engineers (IEEE) 802.1x standard for port based network access control to provide authentication credentials to the computing device 102 connected to the secure network 110. Under the 802.1x standard, which is herein incorporated by reference, the computing device 102 is referred to as a supplicant. The port on the network switch 104 to which the computing device is connected is referred to as an authenticator.

The 802.1x enabled network switch 104 can be initially set to an “unauthorized” state. In this state, only 802.1x traffic is allowed to pass through the switch. Other traffic, such as dynamic host configuration protocol (DHCP) and HTTP traffic, is blocked at the data link layer.

The authenticator can send out an extensible authentication protocol (EAP) Request Identity packet to the supplicant 102. The supplicant will then send out an EAP response packet that the authenticator will forward to an authentication server such as the network access controller 106. In one embodiment, the authentication server can be a remote authentication dial in service (RADIUS) server. The authenticating server can accept or reject the EAP request. If the server accepts the request, the authenticator will set the port to an “authorized” mode and normal traffic will be allowed.

As previously discussed, the local switch can be configured to re-authenticate the credentials after a predetermined period based on the length of time that the temporary credentials are authorized for. This limits the supplicant's access to the secure network through the authenticator to a limited amount of time. Once the authenticator allows access to the server for the predetermined period, the authentication server or another computer within the secure network 110 can be used to reconfigure the computing device 102 to receive information in a secure manner. For example, the computing device may be reconfigured based on various standards such as secure state processing (SSP), secure shell (SSH), and secure socket layer (SSL) to enable information to be communicated in a secure manner.

In one embodiment, enduring credentials can be communicated using secure hyper text transfer protocol (HTTPS). Then the temporary credentials can be erased from any logs or memory within the computing device 102. The enduring credentials can be recorded in reconfiguration logs in the secure encrypted format. The reconfiguration logs can then be monitored by the authentication server 106 and/or authenticator 104. If there is an unexpected event, as previously discussed, a security flag can be raised and appropriate action can be taken.

Once the computing device 102 (or a plurality of computing devices) connected to the secure network has received the encrypted enduring credentials, the switch configuration can be changed to re-authenticate on link up/down rather than at a predetermined time, such as every X minutes as was done with the temporary credentials. When the supplicant logs off, he will send an EAP-logoff message to the authenticator. The authenticator will then set the port to the “unauthorized” state, once again blocking all non-EAP traffic. The above process can then be repeated at login. However, once the enduring credentials have been received, they can be submitted automatically by the supplicant 102 to the authenticator 104, which can communicate them to the authentication server 106 within the secure network 110. The authentication server can continue to accept the enduring credentials for the predetermined time period for which they are valid.

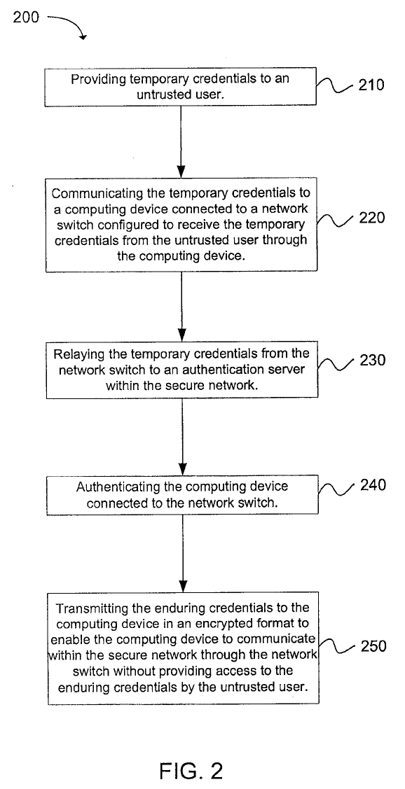

Another embodiment of the present invention provides a method 200 for distributing enduring credentials for a secure network in an untrusted network environment, as illustrated in the flow chart depicted in FIG. 2. The method includes the operation of providing 210 temporary credentials to an untrusted user. The credentials can include at least one of a user name and a password. The credentials can also include physical identification information related to the network switch, the computing device, and the authentication server. The temporary credentials can be provided using a web server located outside the secure network. Alternatively, the temporary credentials may be provided using a more conventional means, such as by telephone, fax, e-mail, and the like. The temporary credentials can be replicated and communicated to an authentication server within the secure network.

The method 200 includes an additional operation of communicating 220 the temporary credentials to a computing device connected to a network switch. The network switch can be configured to receive the temporary credentials from the untrusted user through the computing device. The network switch can be configured to receive the temporary credentials using the IEEE 802.1x standard. An additional operation includes relaying 230 the temporary credentials from the network switch to an authentication server within the secure network. This operation can also be accomplished using the IEEE 802.1x standard.

The method 200 also provides for authenticating 240 the computing device connected to the network switch. Authentication of the computing device can be accomplished by communicating at least one feature of the computing device to the authentication server. The feature may be a unique feature, or a feature that the computing device is known to include, such as a serial number, a MAC address, and the like. Authentication of the computing device may be accomplished using the authentication server or another computer or device located within the secure network.

Once it has been determined that the computing device is approved to be connected to the secure network, the method 200 includes the operation of transmitting 250 the enduring credentials to the computing device in an encrypted format to enable the computing device to communicate within the secure network through the network switch without providing access to the enduring credentials to the untrusted user. The enduring credentials may also be communicated based on the IEEE 802.1x standard. A computer within the secure network, such as the authentication server, can be enabled to configure the computing device to receive the enduring credentials in the encrypted format. The authentication server, or another computer within the secure network can also be configured to validate the enduring credentials for a set period of time. The period of time can be allocated by the provider of the temporary credentials. The period of time can be for days, weeks, or even years, based on the business model that the secure network is operated on. In one embodiment, the enduring credentials can be permanent credentials that are valid so long as no security flags are raised with respect to the connection of the computing device to the secure network.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. For example, the system and method disclosed can be accomplished using a computer usable medium having computer readable program code embodied therein. Accordingly, it is not intended that the invention be limited, except as by the claims set forth below.

What is claimed is:

1. A method for distributing enduring credentials for a secure network in an untrusted network environment, comprising:
providing temporary credentials to an untrusted user;
communicating the temporary credentials to a computing device connected to a network switch configured to receive the temporary credentials from the untrusted user through the computing device;
relaying the temporary credentials from the network switch to an authentication server within the secure network;
authenticating the computing device connected to the network switch; and
transmitting the enduring credentials to the computing device in an encrypted format to enable the computing device to communicate within the secure network through the network switch without providing access to the enduring credentials to the untrusted user.

2. A method as in claim 1, wherein providing temporary credentials further comprises providing at least one of a user name and a password that provides temporary access to the secure network through the network switch.

3. A method as in claim 1, wherein providing temporary credentials further comprises providing physical identification information related to at least one of the computing device and the network switch to the authentication server.

4. A method as in claim 1, further comprising providing temporary credentials to the untrusted user using a web server located outside the secure network.

5. A method as in claim 4, further comprising replicating the temporary credentials from the web server to the at least one server within the secure network.

6. A method as in claim 1, communicating the temporary credentials further comprises communicating the temporary credentials to the network switch based on the Institute of Electrical and Electronics Engineers (IEEE) standard 802.1x.

7. A method as in claim 1, wherein authenticating the computing device further comprises communicating at least one feature of the computing device to the authentication server to verify that the computing device is approved to connect with the secure network.

8. A method as in claim 1, wherein transmitting enduring credentials further comprises transmitting enduring 802.1x credentials to the computing device in the encrypted format to enable the computing device to continue to communicate within the secure network through the network switch for a predetermined period of time.

9. A method as in claim 1, wherein transmitting enduring credentials further comprises transmitting permanent 802.1x credentials to the computing device in the encrypted format to enable the computing device to continue to communicate within the secure network through the network switch indefinitely.

10. A method as in claim 1, wherein the untrusted user is an untrusted client that is an automated device.

11. A system for distributing enduring credentials to a computing device in an untrusted environment, comprising:
a network switch configured to communicate with the computing device and at least one server within a secure network;
an authentication server within the secure network configured to receive temporary credentials from the computing device and verify that the computing device is allowed to communicate with the secure network, wherein the temporary credentials are configured to enable an untrusted user temporary access to the secure network using the computing device connected to the secure network through the network switch; and
computer readable storage accessible by the authentication server and organized to contain enduring credentials provided by the authentication server to the computing device upon verification of the computing device, wherein the enduring credentials are encrypted such that the untrusted user does not have access to the enduring credentials.

12. A system as in claim 11, further comprising a server located within the secure network, the server being operable to reconfigure the computing device to enable the computing device receive the encrypted enduring credentials over a secure connection with the secure network.

13. A system as in claim 11, further comprising a temporary credentials source configured to provide temporary credentials to the untrusted user, wherein the temporary credentials source is selected from the group consisting of a web server, a fax machine, and a telephone connection.

14. A system as in claim 13, wherein the authentication server within the secure network is configured to receive the temporary credentials from the web server.

15. A system as in claim 11, wherein the enduring credentials of the computing device to communicate within the secure network through the network switch are revoked at the network switch by the authentication server when an unexpected event occurs.

16. A system as in claim 15, wherein the unexpected event is selected from the group consisting of a change in location of the computing device, a disconnection of the computing device from the network switch, a change in hardware in the computing device, a change in software in the computing device, a change in firmware in the computing device, a change in a media access control address of the computing device, and a change in an internet protocol address of the network switch.

17. A system as in claim 11, wherein the authentication server is configured to authenticate the temporary credentials and the enduring credentials based on the Institute of Electrical and Electronics Engineers (IEEE) 802.1x standard for port based network access control to provide authentication to the computing device connected to the secure network through the network switch.

18. A system as in claim 11, wherein the network switch is an 802.1x standardized network switch.

19. A system as in claim 11, wherein the enduring credentials authorize access for the computing device to be connected to the secure network through the network switch for a predetermined period of time.

20. A computer usable medium having computer readable program code embodied therein for distributing enduring credentials for a secure network in an untrusted network environment, the computer readable program code in a computer program product comprising:
providing temporary credentials to an untrusted user;
communicating the temporary credentials to a computing device connected to a network switch configured to receive the temporary credentials from the untrusted user through the computing device;
relaying the temporary credentials from the network switch to an authentication server within the secure network;
authenticating the computing device connected to the network switch; and
transmitting the enduring credentials to the computing device in an encrypted format to enable the computing device to communicate within the secure network through the network switch without providing access to the enduring credentials to the untrusted user.
